(19) United States
(12) Patent Application Publication
(10) Pub. No.: US 2006/0032326 A1
(43) Pub. Date: Feb. 16, 2006

(54) Locking bicycle handlebar grip

(76) Inventor: Lee Griswold, Bethel, CT (US)

Correspondence Address: ST. ONGE STEWARD JOHNSTON & REENS, LLC, 986 BEDFORD STREET, STAMFORD, CT, 06905-5619, US

(21) Appl. No.: 11/203,523

(22) Filed: Aug. 12, 2005

Related U.S. Application Data
(60) Provisional application No. 60/600,974, filed on Aug. 12, 2004.

(51) Int. Cl. B62K 21/26

(52) U.S. Cl. 74/551.9

(57) ABSTRACT

A handle bar locking assembly for rigidly fixing a handle bar grip to a handle bar, the locking assembly engaging with the inside diameter of the handle bar by means of laterally or radially spreading wedge member(s) that are displaced radially outwardly upon the turning of a drive element. The drive element axially displaces a locking member having a surface that engages with a surface of the wedge member(s) to cause the radial displacement.

### PRIORITY DOCUMENTS

This applicaiton claims the benefit of the filing date of U.S. Provisional Patent Application Ser. No. 60/600,974 filed Aug. 12, 2004.

### FIELD OF THE INVENTION

The invention relates to handle bar grips, and more specifically to handle bar grips that may be securely fastened to bicycle handles to prevent slippage.

### BACKGROUND OF THE INVENTION

Bicycle handle bars have been furnished for many years with different types of grips to allow the rider to more firmly grip the handle bars. Typically these handle bar grips have comprised a material that is applied to the outside of the handle bar such as, for example, a tape that is wrapped around the handle bar or a molded covering such as a foam or a plastic or combinations thereof to provide cushioning for the user's hands.

A problem that all of these grips experience is movement, including for instance, rotational or axial movement of the grip relative to the handle bar. Typically, handle bar grips are held to the handle bar by means of an interference fitting or by use of an adhesive, or combinations thereof. However, over time, with the above-listed attachment methods, the handle bar grips typically rotate about the handle bar, or begin to detach or slide axially along the length of the of the handle bar do to, for example, pressure from the rider's grip. This is undesirable because the handle bar grip may become damaged over time, failing to provide a cushioned surface for the rider. Additionally, another danger associated with slipping handle bar grips is that the rotating or sliding grip does not provide a secure hand-hold to the handle bar for the rider, and it becomes unsafe; especially is this so in mountain biking applications.

External attachment devices have also been used in connection with handle bar grips; however, these are typically undesirable because they do not present a smooth surface for the rider to grip. Having any type of hard protrusion associated with the external surface of the handle bar grip can also be potentially dangerous to the rider, especially in mountain biking applications. External attachment devices are also typically unsightly.

Therefore, what is desired is a hand grip for use with a bicycle handle bar that will maintain the hand grip stationary with respect to the handle bar over time.

It is further desired to provide a handle bar grip that provides the rider with a secure hand hold during prolonged use.

It is still further desired to provide a handle bar grip that presents a smooth outer surface area for the rider to grip.

It is also desired to provide a secure handle bar grip that does not use an unsightly attachment device.

### SUMMARY OF THE INVENTION

These and other objects are achieved by the provision of a grip for use with a bicycle handle bar that effectively prevents the bicycle grip from rotating on the handle bar and from detaching or sliding off the handle bar even after prolonged use.

In one advantageous embodiment of the present invention, a handle bar grip is designed to clamp or be secured to the inside diameter (ID) of the handle bar rather than only clamping to the outside diameter (OD) of the handle bar, as typically is the case. This is accomplished by provision of a bar plug/handle bar end protector integrated into the grip itself such that, when the grip is slid over the handle bar, the bar plug is inserted inside the end of the hollow handle bar. In this manner, the bar plug is inserted in the handle bar tube end, while a ridged grip substrate is slid over the outside of the handle bar tube end to provide an area for the gripping surface. The grip substrate may be solidly attached at an outer end to the bar plug to form, for example, a unitary structure.

In order to firmly fix the grip to the handle bar, an expandable locking feature may be integrated with the substrate of the grip. In one advantageous embodiment the substrate may comprise, for example, a polymer such as a hard plastic. In addition, a conical or wedge-shaped component of the expander may comprise an insert molded into the ridged plastic substrate. In another advantageous embodiment the conical or wedge-shaped component may comprise, for instance, a metal component.

It is further contemplated that a dual density handle bar grip may also be provided to give, on the one hand, a robust connection to the handle bar, while at the same time providing a relatively soft surface for the rider to grip.

In one advantageous embodiment a bicycle handle bar grip locking assembly for securing a handle bar grip to a handle bar is provided comprising, a handle bar grip substrate for fitting over an outside of the handle bar and a locking element for securing the handle bar grip substrate to the handle bar, the locking element engaging with an inner surface of the handle bar. The locking element includes a first locking member having a first locking member surface, and a second locking member having a second locking member surface, the second locking member being axially movable along a length of the handle bar grip substrate relative to the first locking member. The locking element further includes a wedge member having a wedge surface that is engagable with the first and second locking member surfaces and a locking surface that is engagable with the inner surface of the handle bar, and a drive element for moving the second locking member relative to the first locking member. The assembly is provided such that when the second locking member is moved axially with respect to the first locking member, the wedge member is laterally displaced to engage with the inner surface of the handle bar.

In another advantageous embodiment a bicycle handle bar grip locking assembly for securing a handle bar grip to a handle bar is provided, the handle bar having an Outside Diameter (OD) and an Inside Diameter (ID). The assembly comprises, a handle bar grip substrate for fitting over the OD of the handle bar, and a locking element for securing the handle bar grip substrate to the ID of the handle bar. The locking element includes a locking member having a locking member surface, a wedge member having a wedge surface that is engagable with the locking member surface and a locking surface that is engagable with the ID of the handle bar, and a drive element for moving the locking member relative to the wedge member. The assembly is provided such that when the locking member is moved axially with respect to the wedge member, the wedge member is laterally displaced to engage with the ID of the handle bar.

In still another advantageous embodiment, a bicycle handle bar grip locking assembly for securing a handle bar grip to a handle bar is provided, the assembly comprising, a handle bar grip substrate adapted to be fit over an outside of the handle bar, and a locking element for securing the handle bar grip substrate to the handle bar, the locking element engaging with an inner surface of said handle bar. The locking element includes, a first end, a second end, and a middle portion disposed between the first end and the second end, and a drive element for moving the second end axially toward the first end and for causing the middle portion to expand radially so as to engage the inner surface of the handle bar, thereby securing the handle bar grip to the handle bar.

Other objects of the invention and its particular features and advantages will become more apparent from consideration of the following drawing and accompanying description.

### BRIEF DESCRIPTION OF THE DRAWINGS

FIG. 1 is a sectional drawing of the handle bar locking assembly according to one advantageous embodiment of the present invention;

FIG. 1A is an alternate embodiment of the handle bar locking assembly of FIG. 1;

FIG. 2 is a sectional drawing of the handle bar locking assembly according to FIG. 1; and

FIG. 3 is another sectional drawing of the handle bar locking assembly according to FIG. 1.

### DETAILED DESCRIPTION OF THE DRAWINGS

Referring now to the drawings, wherein like reference numerals designate corresponding structure throughout the views.

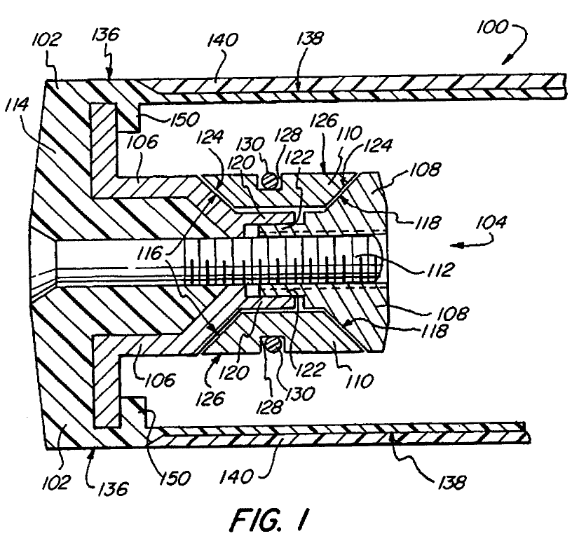

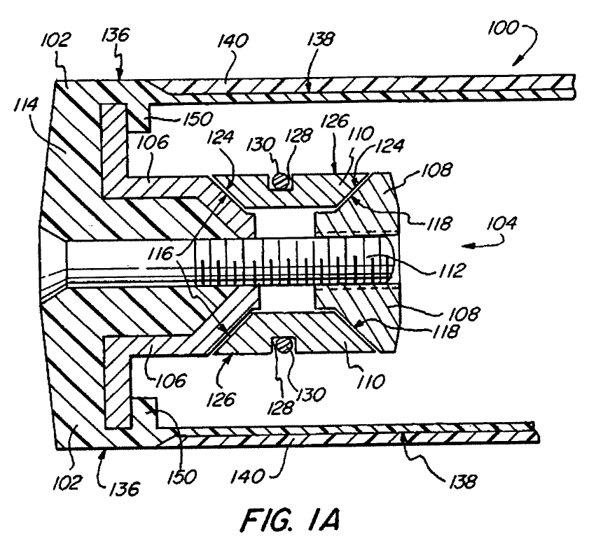

Referring now to FIGS. 1-3, the handle bar grip locking assembly 100 is illustrated as a sectional view. The handle bar grip locking assembly 100 in this advantageous embodiment comprises a handle bar grip substrate 102, and a locking element 104.

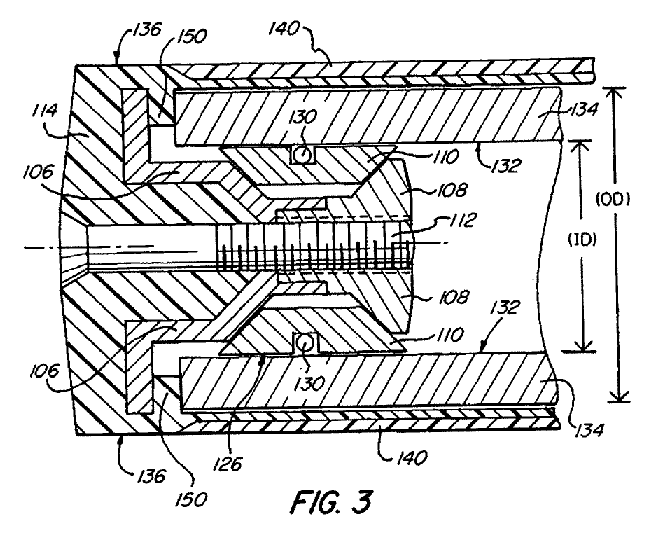

The handle bar grip substrate 102 is advantageously provided as a rigid material, such as for example, a hard polymer or plastic. It is further contemplated that the handle bar grip substrate 102 be provided as a single molded unitary structure. Provided toward end 114 of handle bar grip substrate 102, is shoulder 152. Shoulder 152 provides a reduced inside diameter for handle bar grip substrate 102 for engaging with an inserted handle bar 134 (FIG. 3).

The locking element 104 may in one advantageous embodiment include first locking member 106, second locking member 108, wedge member 110 and drive element 112.

First locking member 106 as illustrated abuts an end 114 of handle bar grip substrate 102 and presents a first locking member surface 116 for wedge member 110 to engage. First locking member 106 may be provided as an aluminum metal insert. Additionally, second locking member 108 presents a second locking member surface 118 for wedge member 110 to engage. Second locking member 108 may also comprise, for example, aluminum. First and second locking members 106, 108 may in one embodiment, be provided with protrusions 120, 122, which overlap each other. It should however, be noted that protrusions 120, 122 may be eliminated if desired as is illustrated in FIG. 1A. In either case, first and second locking members 106, 108 are moveable relative to each other, such that wedge member 110 may be laterally displaced.

Wedge member 110 is also provided with wedge surface 124 that is provided to engage with first and second locking member surfaces 116, 118. Wedge member 110 may also comprise aluminum. Wedge member 110 is further provided with a locking surface 126, having in one advantageous embodiment, a cavity 128 for receiving an O-ring 130. The O-ring 130 resides in cavity 128 such that it is substantially below locking surface 126. O-ring 130 is provided to bias wedge member 110 against first and second locking member 106, 108 when, for instance, handle bar grip locking assembly 100 is not in an engaged or locked position.

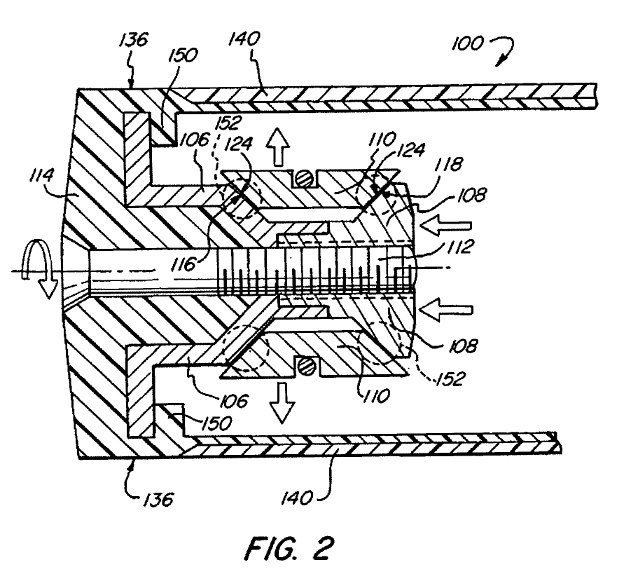

As illustrated in FIG. 2, teeth 152 are provided on first locking member 106 and second locking member 108 (the dashed circles indicate the location of the teeth 152). The teeth prevent axial movement between first locking member 106 and wedge member 110. Preventing this type of movement is advantageous because, If movement is allowed, the rotational force of the riders hand, while gripping and operating the bike, could disadvantageously loosen locking mechanism 104.

Drive element 112 is provided, in this advantageous embodiment, in the form of a screw extending from end 114 and engages with second locking member 108. It is contemplated that drive element 112 may comprise for example, aluminum, steel or titanium.

As illustrated in FIG. 2, drive element 112 may be rotated clockwise or counterclockwise to axially displace second locking member 108 relative to first locking member 106 along a length of handle bar grip locking assembly 100. Displacement of second locking member 108 toward end 114 will cause wedge member 110, due to engagement with first and second locking member surfaces 116, 118 to be laterally displaced outwardly.

As seen in FIG. 3, when wedge member 110 is laterally displaced outwardly, locking surface 126 will come into contact with inner surface of handle bar 134. The more drive element 112 is turned the farther wedge member 110 is laterally displaced making the engage of handle bar grip locking assembly 100 secure with handle bar 134.

Provided on an outer surface 136 of handle bar grip substrate 102 is a depression 138. Soft grip 140 is positioned in depression 138 and may in one advantageous embodiment, be provided flush with outer surface 136. It is contemplated that soft grip 140 may comprise for example, a foam or soft tape.

It can be seen then that handle bar grip locking assembly 100 may quickly and easily be firmly secured to handle bar 134. Handle bar grip locking assembly 100 is simply slid over the Outside Diameter (OD) of the end of handle bar 134. Once accomplished, the locking element 104 engages with the Inside Diameter (ID) of handle bar 134 (FIG. 3).

Drive element 112, which may comprise for example, a screw, may be tightened once the grip is completely inserted on handlebar 134. As drive element 112 is tightened, locking member 108, which may comprise for example, a conical nut, is pulled toward drive element 112. This acts to compress the wedge member 110, which may comprise for example, knurled cylinder segments (in this embodiment there are three) and are held in place by O-ring 130. In this particular embodiment the knurled cylinder segments (110) have been provided having corresponding conical surfaces. While in the embodiment three wedge members 110 are described, it is contemplated that any number of wedge members may effectively be utilized.

As the knurled cylinder segments are compressed they are displaced away from each other in a radial manner which in turn causes an increase in the virtual diameter of the locking element 104. These knurled cylinder segments then come in contact with and clamp to the ID of the handlebar 134 so as to prevent the entire grip assembly 100 from rotating and moving axially with respect to the handle bar 134.

Although the invention has been described with reference to particular ingredients and formulations and the like, these are not intended to exhaust all possible arrangements or features, and indeed many other modifications and variations will be ascertainable to those of skill in the art.

What is claimed is:

1. A bicycle handle bar grip locking assembly for securing a handle bar grip to a handle bar comprising:
a handle bar grip substrate for fitting over an outside of the handle bar;
a locking element for securing said handle bar grip substrate to the handle bar, said locking element engaging with an inner surface of said handle bar and including:
a first locking member having a first locking member surface;
a second locking member having a second locking member surface, said second locking member being axially movable along a length of said handle bar grip substrate relative to said first locking member;
at least one wedge member having a wedge surface that is engagable with the first and second locking member surfaces and a locking surface that is engagable with the inner surface of said handle bar;
a drive element for moving said second locking member relative to said first locking member;
wherein when said second locking member is moved axially with respect to said first locking member, said wedge member is laterally displaced to engage with the inner surface of said handle bar.

2. The bicycle handle bar grip locking assembly according to claim 1 wherein said drive element comprises a screw.

3. The bicycle handle bar grip locking assembly according to claim 1 wherein said first locking member, said second locking member and said wedge member comprise aluminum.

4. The bicycle handle bar grip locking assembly according to claim 1 wherein said handle bar grip substrate comprises a ridged polymer.

5. The bicycle handle bar grip locking assembly according to claim 1 further comprising a gripping surface provided on the exterior of said handle bar grip substrate.

6. The bicycle handle bar grip locking assembly according to claim 5 further comprising a depression located on an exterior surface of said handle bar grip substrate, said depression having the gripping surface located therein.

7. The bicycle handle bar grip locking assembly according to claim 1 further comprising an O-ring extending around said wedge member to provide a biasing force such that the wedge member remains in contact with said first and second locking members.

8. The bicycle handle bar grip locking assembly according to claim 7 further comprising a cavity located in said wedge member, said cavity receiving the O-ring therein.

9. The bicycle handle bar grip locking assembly according to claim 8 wherein said O-ring is positioned in said cavity such that the O-ring is at least below the locking surface of said wedge member.

10. The bicycle handle bar grip locking assembly according to claim 1 wherein said at least one wedge member comprises three wedge members.

11. The bicycle handle bar grip locking assembly according to claim 1 wherein said second locking member comprises a conical nut and engages with said drive element.

12. The bicycle handle bar grip locking assembly according to claim 1 wherein said first locking member surface and said wedge surface comprise teeth for preventing rotational movement between said wedge member and said locking element.

13. The bicycle handle bar grip locking assembly according to claim 12 wherein said second locking member surface and said wedge surface comprise teeth for preventing rotational movement between said wedge member and said locking element.

14. A bicycle handle bar grip locking assembly for securing a handle bar grip to a handle bar, the handle bar having an Outside Diameter (OD) and an Inside Diameter (ID), the assembly comprising:
a handle bar grip substrate for fitting over the OD of the handle bar;
a locking element for securing said handle bar grip substrate to the ID of the handle bar including:
a locking member having a locking member surface;
a wedge member having a wedge surface that is engagable with the locking member surface and a locking surface that is engagable with the ID of said handle bar;
a drive element for moving said locking member relative to said wedge member;
wherein when said locking member is moved axially with respect to said wedge member, said wedge member is laterally displaced to engage with the ID of said handle bar.

15. The bicycle handle bar grip locking assembly according to claim 14 wherein said drive element comprises a screw.

16. The bicycle handle bar grip locking assembly according to claim 14 wherein said locking member and said wedge member comprise aluminum.

17. The bicycle handle bar grip locking assembly according to claim 14 wherein said handle bar grip substrate comprises a ridged polymer.

18. The bicycle handle bar grip locking assembly according to claim 14 further comprising a gripping surface provided on the exterior of said handle bar grip substrate.

19. The bicycle handle bar grip locking assembly according to claim 14 further comprising an O-ring extending around said wedge member to provide a biasing force such that the wedge member remains in contact with said locking member.

20. A bicycle handle bar grip locking assembly for securing a handle bar grip to a handle bar, said assembly comprising:
a handle bar grip substrate adapted to be fit over an outside of the handle bar;
a locking element for securing said handle bar grip substrate to the handle bar, said locking element engaging with an inner surface of said handle bar and comprising:
a first end, a second end, and a middle portion disposed between the first end and the second end; and
a drive element for moving the second end axially toward the first end and for causing the middle portion to expand radially so as to engage the inner surface of said handle bar, thereby securing the handle bar grip to the handle bar.
